(19) United States
(12) Patent Application Publication
(10) Pub. No.: US 2008/0122169 A1
(43) Pub. Date: May 29, 2008

(54) Transfer Drum for Conveying a Sheet

(75) Inventors: Stefan Mutschall, Ostringen (DE); Peter Thoma, Mannheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/945,652

(22) Filed: Nov. 27, 2007

(30) Foreign Application Priority Data
Nov. 27, 2006 (DE) DE102006055901.0

(51) Int. Cl. B41F 21/10; B65H 5/12

(52) U.S. Cl. 271/276; 271/277

(57) ABSTRACT

A transfer drum for conveying sheets includes a revolving drum body, gripper systems provided on the drum body for holding the sheet at a leading margin thereof, and at least two rigid carrier elements having a cylinder-shell shape and being adjustable relative to the drum body. The carrier elements are disposed so as to be translationally displaceable relative to the drum body.

### CROSS-RELATED REFERENCE TO RELATED APPLICATION

This application claims the priority, under 35 U.S.C. § 119, of German Patent Application DE 10 2006 055 901.0, filed Nov. 27, 2006; the prior application is herewith incorporated by reference in its entirety.

### BACKGROUND OF THE INVENTION

### Field of the Invention

The invention relates to a transfer drum for conveying a sheet. The transfer drum includes a revolving drum body, gripper systems provided on the drum body for holding the sheet at a leading margin thereof, and at least two rigid carrier elements having a cylinder-shell shape and being adjustable relative to the drum body.

A transfer drum for conveying a sheet is formed of a rotatably mounted drum body whereon at least one mechanical or pneumatic gripper system for holding the sheet at a leading sheet margin thereof is disposed. The gripper system is made up of a plurality of individual grippers which are disposed along a gripper-closing line in parallel with the axis of rotation of the drum body. As the drum body rotates, the gripper-closing line defines a revolution contour in the shape of the jacket surface of a cylinder. The grippers of the gripper system interact or cooperate with grippers of neighboring drums or cylinders. When a sheet is taken over or transferred, the grippers of the neighboring drums or cylinders may dip into clearances or gaps formed within the revolution contour of the transfer drum. A transfer drum may be formed with a closed revolution contour or an open revolution contour. A closed revolution contour results from at least one rigid cylinder jacket-shaped carrier element whereon a sheet lies as the sheet is being conveyed. If the side of the sheet that lies on the carrier element has printing thereon, the support or bearing surface of the carrier element may have an ink-repellent construction. If the revolution contour is open, the sheet is gripped exclusively at the leading margin thereof as it is conveyed and is otherwise guided freely. In this case, the drum body profile is retracted to such an extent that the free or overhung end of the sheet does not collide with the drum body and the extensions secured thereto.

In rotary printing presses, the effective diameter of the revolution contour of a transfer drum is dependent upon the diameter of the printing form cylinders or printing-plate cylinders. In a single-revolution press, precisely one sheet is printed on one side during each revolution of a printing-plate cylinder. There are sheet-fed printing presses that use transfer drums having a diameter which is a multiple of the diameter of an associated printing-plate cylinder. Presses with half-revolution impression cylinders use double-diameter transfer drums between the impression cylinders of neighboring printing units.

In German Published, Non-Prosecuted Patent Application DE 199 12 709 A1, corresponding to European Patent EP 1 044 812 B1, there is shown a transfer drum with two pivotable drum caps. For the purpose of transporting cardboard sheets, the drum caps are pivoted inwardly, thereby creating clearances wherein the cardboard boxes, which are resistant to bending, can be relieved of tension without causing damage to a printed or varnished area. For pivoting purposes, the drum caps are pivotally supported in the vicinity of the gripper systems and are coupled to an operative cylinder. Due to the pivoting geometry, the possible clearances are limited, so that a risk of collisions between sheets and components cannot be fully excluded.

In European Patent Application EP 1 010 526 A1, corresponding to Patent Abstracts of Japan JP 2000 177 104A, there is disclosed a double-diameter transfer drum that includes two pivotable carrier plates for every jacket surface segment. The respective carrier plates are pivotally supported in the vicinity of the gripper system. In an inwardly pivoted condition of the carrier plates, they overlap one another. In a condition wherein the carrier plates have been pivoted outwardly, the carrier plates form support surfaces having the shape of cylinder jackets, thereby forming a seam that may have a detrimental effect upon the print quality.

The double-diameter vario drum disclosed in German Published, Non-Prosecuted Patent Application DE 103 55 045 A1, corresponding to U.S. Patent Application Publication No. US 2004/013512 A1, includes pivotable and reversibly deformable jacket segments which are mounted in hinge bearings in the vicinity of a respective gripper system. The jacket segments are formed of a resilient material, so that, for changes in speed, they have a reduced dimensional stability. Dimensionally unstable jacket segments cannot ensure identical conveying conditions for a sheet.

### SUMMARY OF THE INVENTION

It is accordingly an object of the invention to provide a transfer drum for conveying a sheet, which overcomes the hereinafore-mentioned disadvantages of the heretofore-known devices of this general type, which permits adaptation or adjustment thereof to a mode of operation of a typographic or printing technology machine and which includes carrier elements that are disposable or adjustable so as to avoid undesirable influences on the sheet.

With the foregoing and other objects in view, there is provided, in accordance with the invention, a transfer drum for conveying a sheet. The transfer drum comprises

a revolving drum body, gripper systems provided on the drum body for holding the sheet at a leading margin thereof, and at least two rigid carrier elements having a cylinder-shell shape and being adjustable relative to the drum body. The carrier elements are disposed so as to be translationally displaceable relative to the drum body.

In accordance with another feature of the invention, the transfer drum includes two such gripper systems provided diametrically opposite one another on the drum body. The carrier elements include a respective first carrier element articulating with the drum body following one of the gripper systems. The transfer drum further includes at least one entrainment element by which the respective first carrier element is coupled to a second, displaceable carrier element.

In accordance with a further feature of the invention, the carrier elements are coupled to a pneumatic or hydraulic drive.

In accordance with an added feature of the invention, the carrier elements are simultaneously displaceable.

In accordance with an additional feature of the invention, a lever gearing is provided for simultaneously displacing the carrier elements.

In accordance with yet another feature of the invention, the gripper systems have a revolution contour. The carrier elements are displaceable, from a respective position close to the revolution contour of the gripper systems, into a retracted position close to the drum body.

In accordance with a concomitant feature of the invention, when the carrier elements are in the retracted position thereof, a clearance is formed in front of a respective gripper system, as viewed in the direction of revolution of the drum.

In accordance with the invention, accordingly, carrier elements are provided on a drum body of a transfer drum so as to be displaceable and/or pivotable. When a carrier element is displaced and/or pivoted out of the environment of the revolution contour of the drum into the interior of the drum, the front and rear edges of the carrier elements, as viewed in the direction of revolution, pass through equal distances. Consequently, in the retracted state of the carrier elements, sufficient clearance is created to guide a sheet without collision. In particular, there is a clearance in front of each gripper system, as viewed in the direction of revolution of the drum. The carrier elements, which are curved cylindrically on the outside, may be matched to the geometry of the drum body on the inside, so that a maximum clearance is created in the retracted state. In the case of a drum body with two diametrical gripper systems, two carrier elements may be provided for each drum half. A first carrier element of a drum half may be articulated on the drum body so as to follow a gripper system, and a second carrier element may be displaceable with respect to the drum body and may entrain the first carrier element when the second carrier element is displaced and/or pivoted.

The carrier elements may be coupled to electric, pneumatic or hydraulic drives. In particular, a lever gearing may be provided for moving a number of carrier elements simultaneously. The carrier elements may be capable of being fixed not only in their end positions at the periphery of the transfer drum and at the drum body, but also in intermediate positions. The positions of the carrier elements may be continuously adapted to the conveying conditions, in particular to the speed of the revolution of the transfer drum and the resistance to bending of the sheet. In a printing press with similar-type in-line printing units, a respective transfer drum may be provided downline or downstream of a reversing or turning device between the printing units, and the position of the carrier elements of the transfer drum may be adjusted automatically when the reversing mode is switched on or switched off. In the reversing region, the carrier elements are adjusted outwardly to be close to the revolution contour, whereas during one-sided printing on the sheet, the carrier elements are adjusted inwardly to be close to the drum body.

Other features which are considered as characteristic for the invention are set forth in the appended claims.

Although the invention is illustrated and described herein as embodied in a transfer drum for conveying a sheet, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is a diagrammatic, side-elevational view of printing units located downline of a

reversing device in a sheet-fed printing press;

FIGS. 2 and 3 are respective end-elevational and side-elevational views of a transfer drum with carrier elements that have been moved outwardly;

FIGS. 4 and 5 are respective end-elevational and side-elevational views of a transfer drum with carrier elements that have been moved to an intermediate position;

FIGS. 6 and 7 are respective end-elevational and side-elevational views of a transfer drum with carrier elements that have been moved inwardly;

FIGS. 8.1 and 8.2 are highly diagrammatic, side-elevational views of a carrier element that is fixed to pivoting arms and has a parallel crank mechanism;

FIGS. 9.1 and 9.2 are highly diagrammatic, side-elevational views of a carrier element fixed to parallel guides;

FIGS. 10.1 and 10.2 are highly diagrammatic, side-elevational views of a carrier element fixed to telescopic rods; and

FIGS. 11.1 and 11.2 are highly diagrammatic, side-elevational views of a carrier element that is guided on pivoting arms and has drive elements in sliding guides.

### DETAILED DESCRIPTION OF THE INVENTION

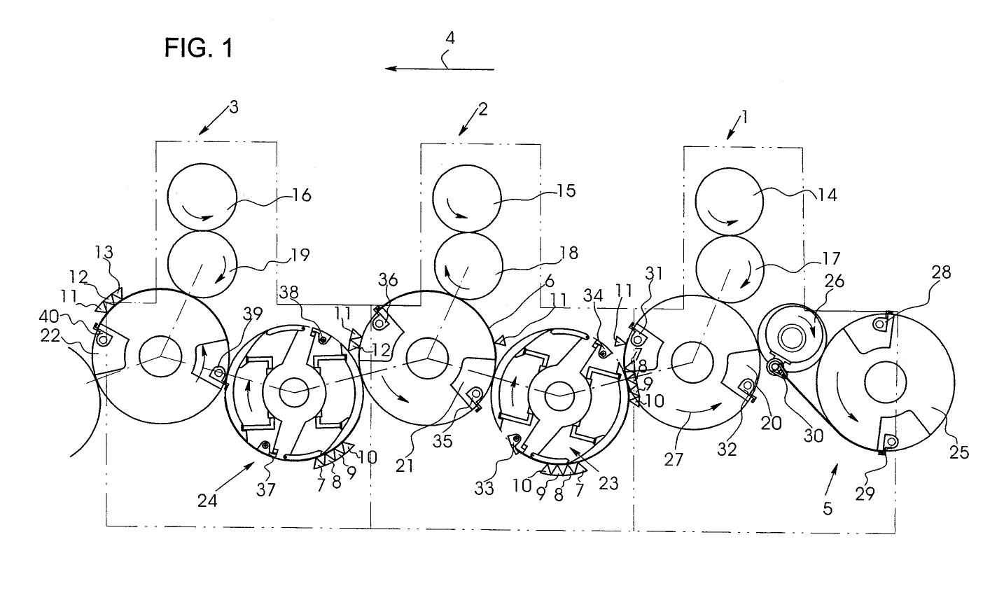

Referring now to the figures of the drawings in detail and first, particularly, to FIG. 1 thereof, there are seen three printing units 1, 2 and 3 of a sheet-fed press of in-line construction. As viewed in the direction of sheet travel represented by a horizontal arrow 4, the printing units 1, 2 and 3 are located downline or downstream of a turning or reversing device 5. Consequently, in the printing units 1-3, sheets 6 that have been provided with printed images 7-10 on a front or first side thereof are provided with further printed images 11-13 on a rear or second side thereof. Each of the printing units 1-3 includes a respective plate cylinder 14-16, a respective transfer cylinder 17-19, and a respective impression cylinder 20-22. Transfer drums 23 and 24 are provided for conveying the sheets between the impression cylinders 20-22. The reversing device 5 is made up of a storage drum 25 and a reversing drum 26. The cylinders 14-19 and the drums 20-26 are driven in synchronism in the direction of arrows 27 by individual drives or by one or more gearing mechanisms. Gripper systems 28-40 which revolve with the impression cylinders 20-22 and with the drums 23-26 are provided for transporting the sheets through the printing press. Each of the gripper systems 28-40 is formed of a row of individual grippers, which grip a leading margin of a respective sheet 6 and are aligned in a row parallel to axes of rotation of the respective cylinders 20-22 or drums 23-26.

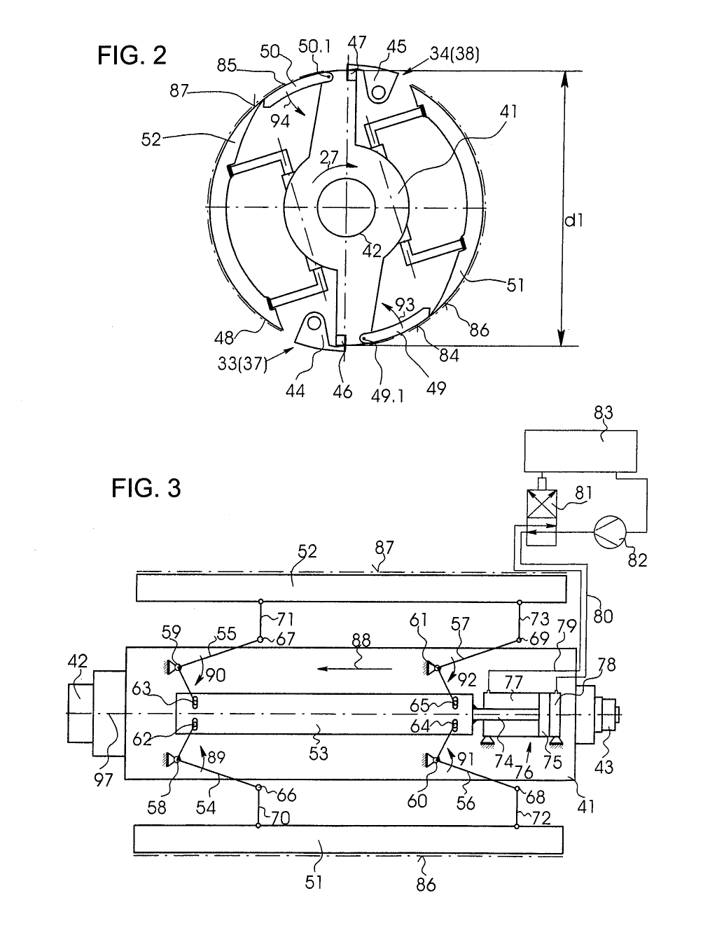

FIGS. 2-7 diagrammatically illustrate the transfer drums 23-24 in a respective profile or end view and a respective side elevational or lateral view. Each of the transfer drums 23, 24 is formed of a drum body 41 having journals 42, 43 which are supported in side walls of the sheet-fed printing press. Gripper systems 33, 34 and 37, 38 are diametrically disposed on the drum body 41. Each of the gripper systems 33, 34 and 37, 38 is formed of a plurality of gripper fingers 44, 45 that are disposed on a gripper shaft so as to be capable of pivoting, and cooperate with gripper pads 46, 47 on the drum body 41. As the transfer drums 23, 24 rotate, the gripper pads 46, 47 are disposed on a cylinder jacket-shaped revolution contour 48 having a diameter d1. Carrier shells 49-52 having a cylinder jacket-shaped outer contour are supported diametrically on the drum body 41. The carrier shells 49, 50 are pivotably supported in bearings 49.1, 50.1 that are located in the vicinity of the gripper shaft of the gripper system 33, 34, both in the radial direction and in the circumferential direction 27. The carrier shells 51, 52 are connected to the drum body 41 as driven elements in a lever gearing. The lever gearing includes a slider 53 as a drive element and angular levers 54-57 as intermediate elements. The angular levers 54-57 are supported in hinge bearings 58-61 on the drum body 41. The ends of the angular levers 54-57 are mounted in respective joints 62-65 and 66-69 on the slider 53 and on respective supports 70-73 of the carrier shells 51, 52. The slider 53 is connected to a piston rod 74 of a piston 75. The piston 75 is disposed in an operative cylinder 76 so as to be displaceable, and divides the operative cylinder 76 into two operating chambers 77, 78. Lines 79, 80 connect the operating chambers 77, 78 to a switch-over valve 81, which is connected to a compressed-air generator 82. The compressed-air generator 82 and the switch-over valve 81 are connected to a control device 83 of the sheet-fed printing press.

As is shown in FIGS. 2 and 3, the piston 75 is in a right-hand end position in the operative cylinder 76. The piston rod 74, the slider 53, and the angular levers 54-57 have adjusted the carrier shells 51, 52 into a radially outward position onto the diameter d1. In this position of the carrier shells 49-52, the sheet-fed printing press is switched to the reversing mode, i.e., the transfer drums 23, 24 convey sheets 6 that have been printed on both sides. In order to avoid damage to the printed images 11-13 as the sheets are conveyed, the carrier shells 49-52 have ink-repellent coatings 84-87 thereon.

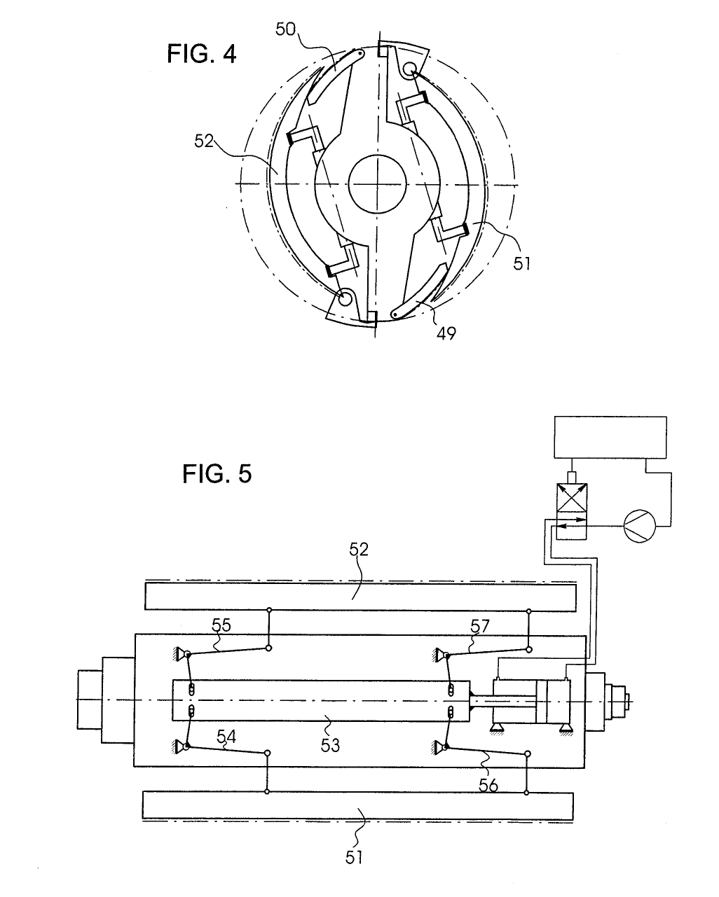

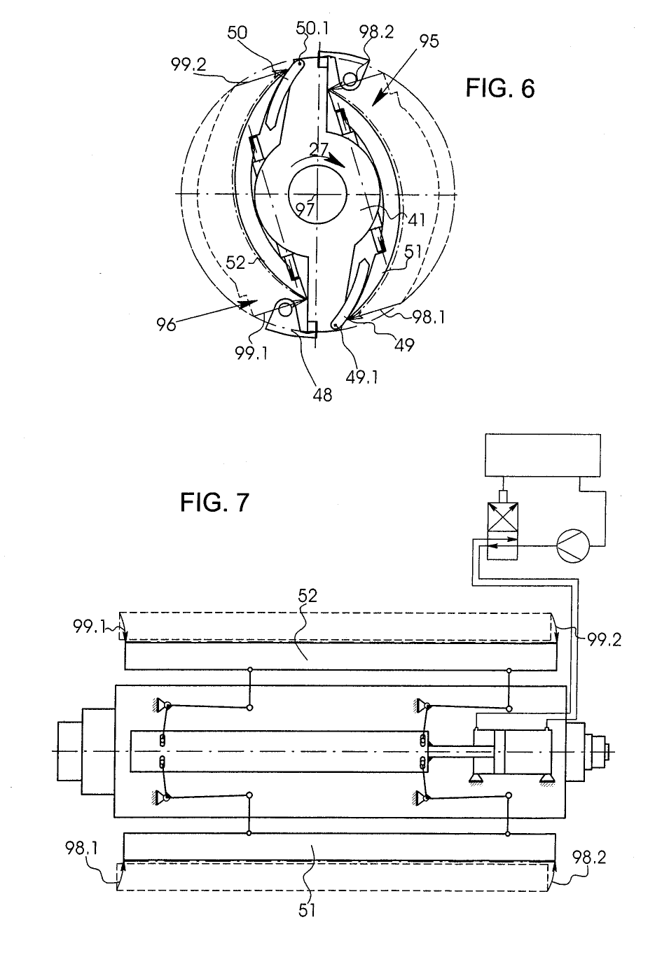

If the sheet-fed printing press is switched from the reversing mode to one-sided printing, the carrier shells 49, 52 are moved into the position shown in FIGS. 6 and 7 and the control device 83 moves the valve 81 into the position shown in FIGS. 3, 5 and 7. The compressed-air generator 82 is switched on to increase pressure in the operative chamber 78. Consequently, the piston 75, the piston rod 74, and the slider 53 move to the left-hand side on the drum body 41 in the axial direction. Due to the axial movement of the slider 53, the angular levers 54-57 are pivoted about the bearings 58-61 in the direction of the arrows 89-92. The carrier shells 49-52 move radially inwardly and reach intermediate positions shown in FIGS. 4 and 5 and second end positions shown in FIGS. 6 and 7. As the carrier shells 51, 52 move inwardly, they entrain the carrier shells 49, 50, which carry out pivoting movements in the direction of the arrows 93, 94 about the bearings 49.1 and 50.1. In the second end positions, the carrier shells 51-52 are located close to the outer contour of the drum body 41. Relative to the revolution contour 48, increasing clearances 95, 96 form against the direction of rotation 27 of the drum body 41 so that a sheet 6 that has been printed on one side can be conveyed without colliding with a component.

As viewed in the direction of the axis of rotation 97, FIGS. 6 and 7 show the outer first end positions of the carrier shells 51, 52 in phantom. As viewed in the profile, the carrier shells 51, 52 carry out translational displacement movements 98.1, 98.2, 99.1, 99.2 as they are moved into the inner second end position. These displacement movements are carried out simultaneously and have the same value and direction for each point.

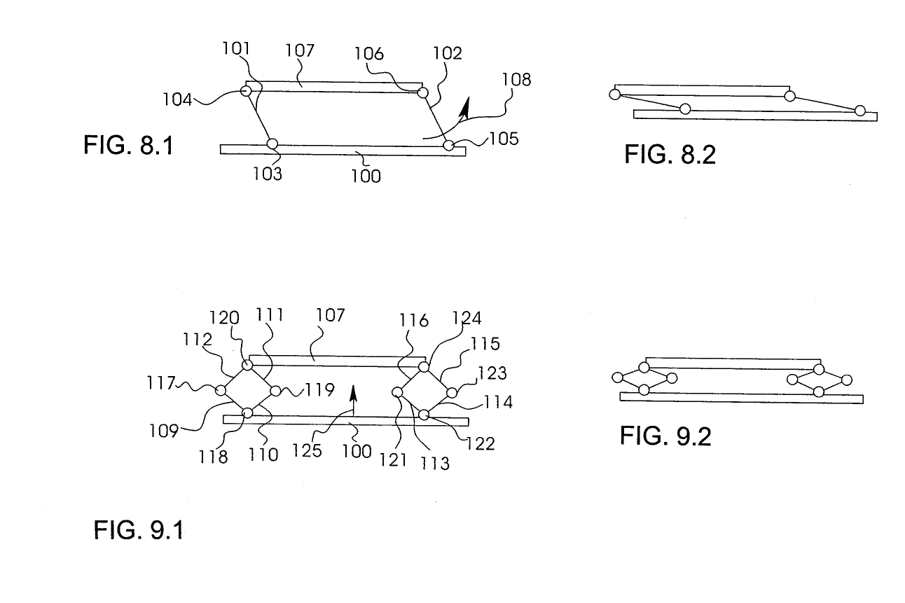

In an alternative embodiment, which is highly diagrammatically illustrated in FIGS. 8.1 and 8.2, a parallel crank chain is provided for the radial adjustment of a carrier shell 100, which is supported on a drum body 107 by parallel pivot arms 101, 102 and joints 103-106. When a radial adjustment is made from the outside to the inside, the carrier shell 100 carries out a pivoting movement 108 about the joints 104, 106.

FIGS. 9.1 and 9.2 highly diagrammatically illustrate a carrier shell 100 that is adjustable by a parallel crank chain including elements 109-116 that are of identical length, disposed in a scissors-type manner, and connected to joints 117-124 to form a joint quadrangle. The joint quadrangle is connected to the carrier shell 100 or respectively with a drum body 107, at respective opposing joints 118, 120; 122, 124. Upon radial adjustment from the outside to the inside, the carrier shell 100 exclusively carries out a translational displacement 125 in the direction of the drum body 107.

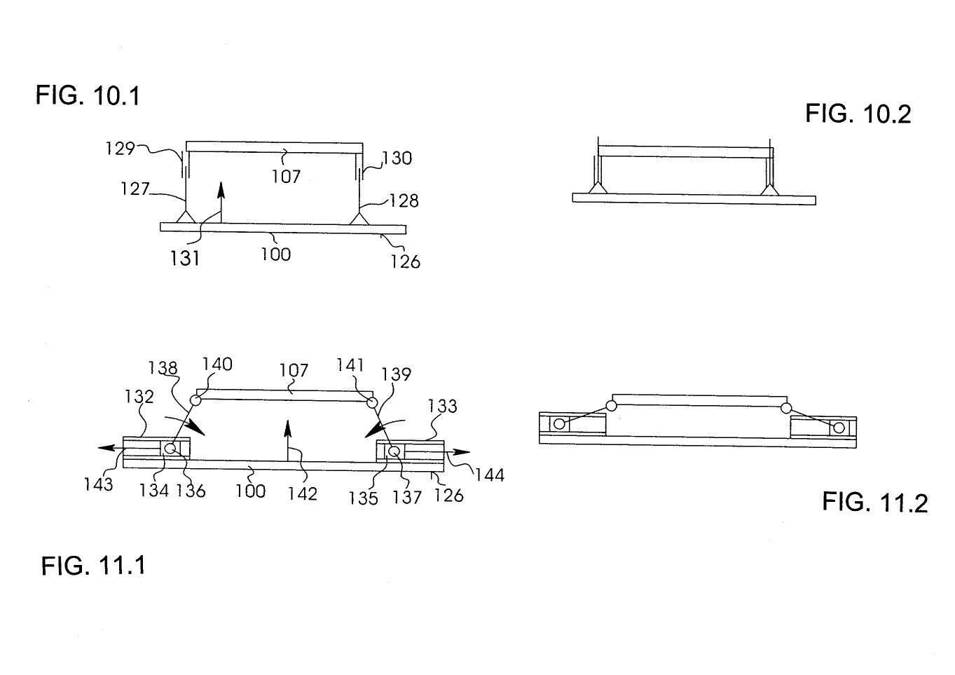

FIGS. 10.1 and 10.2 highly diagrammatically show a straight telescopic guide for a carrier shell 100 relative to a drum body 107. Telescopic rails 127, 128 are attached to the carrier shell 100, perpendicularly to the plane of sheet guidance 126, and cooperate with guide sleeves 129, 130 on the drum body 107. Upon radial adjustment from the outside to the inside, only a translational displacement 131 of the carrier shell 100 in the direction of the drum body 107 is carried out, with the telescopic rails 127, 128 dipping into the guide shells 129, 130.

A device shown in FIGS. 11.1 and 11.2 includes guides 132, 133 for sliding blocks 134, 135. The guides 132, 133 are disposed on a carrier shell 100 so as to be parallel with a plane of sheet guidance 126. Pivot arms 138, 139 are fixed in joints 136, 137 on the sliding blocks 134, 135. The respective other end of a pivot arm 138, 139 is mounted in joints 140, 141 on a drum body 107. Upon radial adjustment from the outside to the inside, the carrier shell 100 exclusively carries out a translational displacement 142 in the direction of the drum body 107, with the sliding blocks 134, 135 being displaced in the guides 132, 133 in an outward direction indicated by arrows 143, 144.

1. A transfer drum for conveying a sheet, the transfer drum comprising:
a revolving drum body;
gripper systems provided on said drum body for holding the sheet at a leading margin thereof; and
at least two rigid carrier elements having a cylinder-shell shape and being adjustable and translationally displaceable relative to said drum body.

2. The transfer drum according to claim 1, which further comprises:
at least one entrainment element;
said gripper systems including two diametrically opposite gripper systems; and
said carrier elements including a first carrier element articulated on said drum body to follow one of said gripper systems, and a second, displaceable carrier element coupled to said first carrier element by said at least one entrainment element.

3. The transfer drum according to claim 1, which further comprises a pneumatic or hydraulic drive coupled to said carrier element.

4. The transfer drum according to claim 1, wherein said carrier elements are simultaneously displaceable.

5. The transfer drum according to claim 4, which further comprises a lever gearing (53-69, 101-106, 109-124, 132-141) for simultaneously displacing said carrier elements.

6. The transfer drum according to claim 1, wherein said gripper systems have a revolution contour, and said carrier elements are displaceable from a respective position close to said revolution contour of said gripper systems into a retracted position close to said drum body.

7. The transfer drum according to claim 6, wherein a clearance is formed in front of a respective gripper system, as viewed in a direction of revolution of the transfer drum, when said carrier elements are in said retracted position.
